(19) United States
(12) Patent Application Publication
(10) Pub. No.: US 2005/0179242 A1
(43) Pub. Date: Aug. 18, 2005

(54) Vehicle front seat configuration

(76) Inventors: Adrian B. Chernoff, Royal Oak, MI (US); Tommy E. White, Rochester Hills, MI (US)

Correspondence Address: KATHRYN A MARRA;General Motors Corporation, Mail Code 482-C23-B21, P.O. Box 300, Detroit, MI, 48265-3000, US

(21) Appl. No.: 10/771,169

(22) Filed: Feb. 3, 2004

(51) Int. Cl. B62D 21/00

(52) U.S. Cl. 280/781

(57) ABSTRACT

A vehicle body includes a floorpan and a front seat having a lower seat portion and a substantially upright seatback portion. The lower seat portion is rigidly fixed with respect to the floorpan such that it is not movable fore or aft by an occupant of the seat. The vehicle body preferably includes a drive-by-wire control input device movable with respect to the front seat. The vehicle body is also preferably characterized by the absence of an engine compartment forward of a passenger compartment.

### TECHNICAL FIELD

This invention relates to vehicle front seats that include a lower seat portion rigidly fixed with respect to a floorpan and not adjustable fore or aft by an occupant.

### BACKGROUND OF THE INVENTION

Prior art vehicles typically have controls for steering, braking, and acceleration that are not repositionable, or that are repositionable within a very limited range of movement. Such controls typically include foot pedals and steering wheels. Prior art vehicles also typically have a front compartment, such as an engine compartment, forward of a passenger compartment.

Correspondingly, typical prior art vehicle front seats are selectively movable fore and aft and up and down so that drivers of differing sizes can comfortably reach the controls and adjust the view over the front compartment. Prior art seat assemblies typically require a significant number of parts to enable selective movability, such as seat tracks, latches, motors, etc.

### SUMMARY OF THE INVENTION

A vehicle body is provided that includes a floorpan partially defining a passenger compartment. A front seat in the passenger compartment includes a lower seat portion and a seatback portion. The lower seat portion is not adjustable fore or aft by an occupant of the seat. The front vehicle seat therefore may be greatly simplified compared to prior art front vehicle seats.

Preferably, the body includes at least one drive-by-wire control input device configured to convert driver-initiated mechanical steering, braking, and propulsion signals to electronic steering, braking, and propulsion signals, respectively. The at least one input device is selectively movable with respect to the front seat so that a driver need not move the seat to comfortably reach the input device. The vehicle body may be characterized by the absence of an engine compartment forward of the passenger compartment. The absence of an engine compartment further reduces the need to adjust the front seat because a driver need not adjust the seat to view over the engine compartment.

The floorpan preferably includes a formation that forms a portion of the front seat, such as the lower seat portion or a structural portion of the seat that supports the lower seat portion above the vehicle floor. The formation may increase the cross-car strength of the floorpan, and correspondingly, the body.

The above features and advantages, and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, partially exploded cross sectional view of a vehicle including a vehicle body with a front seat rigidly mounted to a floorpan taken along a vertical plane;

FIG. 2 is a fragmentary schematic perspective view of the floorpan of FIG. 1;

FIG. 3 is a fragmentary schematic perspective view of the floorpan of FIG. 2 and vehicle seats in an attachment scenario; and

FIG. 4 is a fragmentary schematic perspective view of an alternative floorpan embodiment.

### DESCRIPTION OF THE PREFERRED EMBODIMENTS

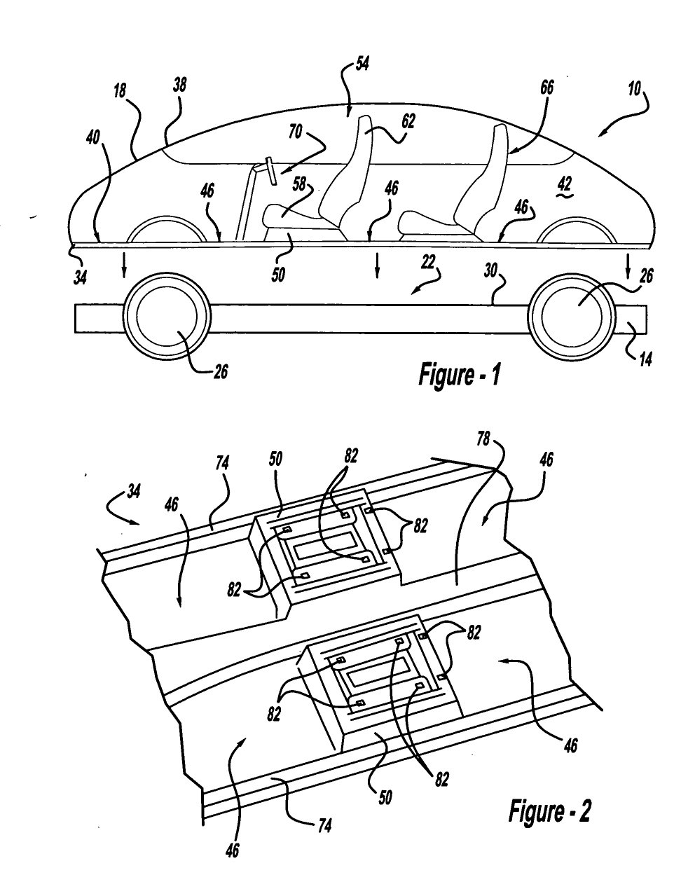

Referring to FIG. 1, a vehicle 10 includes a vehicle chassis 14 and a vehicle body 18. The chassis 14 is described in commonly assigned U.S. Patent Application Ser. Nos. 10/205,483 and 10/205,501, each of which is hereby incorporated by reference in its entirety. The chassis 14 includes a steering system, braking system and energy conversion system, hereinafter referred to as a “propulsion system,” responsive to nonmechanical control signals so that the body attachment interface 22 at which the body 18 is matable to the chassis 14 is characterized by the absence of mechanical control linkages. More specifically, the steering system, braking system, and propulsion system are controllable by-wire, i.e., they are responsive to electronic control signals.

The propulsion system includes a fuel cell for generating electrical energy used by electrical motors to rotate wheels 26. The propulsion system, steering system, and braking system are sufficiently packaged so that the upper face 30 of the chassis 14 is substantially flat.

The body 18 includes a floorpan 34 and an enclosure 38. The floorpan is characterized by upper surface 40. The enclosure and the upper surface cooperate to define a passenger compartment 42. In the embodiment depicted, the floorpan 34 and the passenger compartment 42 extend the length of the chassis 14 such that the body 18 is characterized by the absence of an engine compartment forward of the passenger compartment 42. However, a body may have an engine compartment forward of a passenger compartment within the scope of the claimed invention. The upper surface 40 of the floorpan 34 is characterized by substantially flat portions 46 that function as a vehicle floor. The floorpan includes a protuberant formation 50 that projects upward from flat portions 46.

The formation 50 forms a structural portion of a front seat 54. The front seat includes a lower seat portion 58 and a substantially upright seatback portion 62 rigidly mounted to the formation 50 such that the formation 50 acts as a seat frame to support the lower seat portion 58 and the seatback portion 62 above the flat portions 46 that form the vehicle floor. The vehicle body 18 optionally includes a rear seat 66.

The lower seat portion 58 is directly connected to the formation 50 without an adjustment mechanism that allows the lower seat portion 58 to move relative to the floorpan 34. Thus, an occupant of the front seat 54 cannot move the lower seat portion 58 fore or aft, thereby eliminating the seat tracks employed by prior art front seat apparatuses. The front seat 58 may be adjustable in other ways within the scope of the claimed invention; for example, the lower seat portion 58 may be selectively movable up and down for vertical adjustment, and the seatback portion 62 may be selectively pivotable about an axis for tilt adjustment.

The vehicle body also includes a driver-operable, drive-by-wire control input device 70 for driver control of vehicle speed and direction. In the context of the claimed invention, a “drive-by-wire control input device” is configured to convert at least one of steering, braking, and propulsion system control signals from a mechanical form to a nonmechanical, e.g., electronic, form. The input device 70 depicted includes members (not shown), such as push buttons, levers, hand wheels, etc., manipulable by a driver to generate mechanical steering, braking, and propulsion system control signals. Transducers (not shown) within the input device 70 convert the mechanical steering, braking, and propulsion control signals to electronic steering, braking, and propulsion control signals to which the steering, braking, and propulsion systems are responsive. The input device 70 transmits the electronic control signals to the chassis 14 through an electrical connector (not shown) on the body-attachment interface 22. The input device 70 is selectively movable with respect to the front seat 54.

While the input device 70 depicted is a single, hand-operated unit configured to convert steering, braking, and propulsion system control signals, those skilled in the art will recognize a variety of input device configurations that may be employed within the scope of the claimed invention. For example, a driver-operable, drive-by-wire control input device may be a foot pedal and transducer for braking signals or propulsion signals, a steering wheel with a transducer for steering signals, etc.

While the vehicle depicted in FIG. 1 has a separate body and chassis, and thus employs a variant of body-on-frame architecture, body-frame integral architecture, also known as unibody architecture, may be employed within the scope of the claimed invention.

Referring to FIG. 2, wherein like reference numbers refer to like components from FIG. 1, a portion of the floorpan 34 is schematically depicted. The floorpan includes strengthening formations such as two lateral channels 74 and a center channel 78. The floorpan 34 includes formations 50 forming portions of two front seats. The formations 50 are separated by channel 78. Fastening elements 82 on the formations 50 are engageable with complementary fastening elements on lower seat portions and seatback portions to rigidly mount the lower seat portions and seatback portions to the floorpan 34. The fastening elements 82 depicted are holes in the floorpan 34 through which a threaded fastener (not shown) on a lower seat portion or a seatback portion extends. Those skilled in the art will recognize a variety of fastening elements that may be employed within the scope of the claimed invention, such as latches, cam locks, etc.

The floorpan 34 is preferably one-piece, but may be formed by several pieces within the scope of the claimed invention. For example, in the embodiment depicted, protuberant formations 50 are part of a one-piece floorpan 34. However, within the scope of the claimed invention, the protuberances that form a portion of a front seat may be members affixed to the floorpan, such as by mechanical fasteners or welding.

Those skilled in the art will recognize a variety of materials that may be employed to form the floorpan 34, including various metals and plastics. Those skilled in the art will also recognize a variety of forming techniques that may be employed within the scope of the claimed invention to form the contours of floorpan 34, such as, but not limited to, stamping, injection molding, etc. However, a fluid forming technique such as quick plastic forming, superplastic forming, or sheet hydroforming is preferably employed to form the contours of the floorpan 34 so that the floorpan 34 has a more complex shape than is generally achievable with stamping. Any holes, apertures, and openings in the floorpan are cut, punched, etc, after the contours are formed.

Superplastic forming is described in U.S. Pat. No. 5,974,847, issued Nov. 2, 1999 to Saunders, et al, which is hereby incorporated by reference in its entirety. When certain alloy compositions of steel or aluminum are suitably processed (such as with a very fine grain microstructure), they exhibit superplastic behavior at certain elevated temperatures. When deformed at these temperatures, the ductility (or elongation before yield or failure) of these materials exceeds several hundred percent. Such high levels of ductility can enable fabrication of very complex structures in a single sheet of material. A floorpan 34 of the design discussed above can be fabricated in one piece using such techniques.

In addition to various steels and aluminum alloys, other structural materials such as zinc, brass, magnesium, titanium and their alloys have also been reported to exhibit superplastic behavior. Furthermore, certain polymers and reinforced polymer composites have the required ductility to make the floorpan 34. These materials and other metal matrix composites could also be used to make the floorpan 34 of this invention, if desired.

In an example of superplastic forming (SPF), a blank, i.e., a sheet, is tightly clamped at its edges between complementary surfaces of opposing die members. At least one of the die members has a cavity with a forming surface opposite one face of the sheet. The other die opposite the other face of the sheet forms a pressure chamber with the sheet as one wall to contain the working gas for the forming step. The dies and the sheet are heated to a suitable SPF condition for the alloy. For SPF aluminum alloys, this temperature is typically in the range of 400° C. to 55° C. Electric resistance heating elements are located in press platens or sometimes embedded in ceramic or metal pressure plates located between the die members and the platens. A suitable pressurized gas such as argon is gradually introduced into the die chamber on one side of the sheet, and the hot, relatively ductile sheet is stretched at a suitable rate until it is permanently reshaped against the forming surface of the opposite die. The rate of pressurization is controlled so the strain rates induced in the sheet being deformed are consistent with the required elongation for part forming. Suitable strain rates are usually 0.0001 to 0.01 s⁻¹. During the deformation of the sheet, gas is vented from the forming die chamber.

The '847 patent provides a method of stretch forming a ductile metal sheet into a complex shape involving significant deformation without excessive thinning of the sheet material and without tearing it. The method is particularly applicable to the stretch forming of superplastic alloys heated to a superplastic forming temperature. In the method, additional material from the initially flat sheet blank is pulled or drawn into the forming cavity for stretch forming. The additional material significantly reduces thinning and tearing in the formed part.

The method contributes to thickness uniformity in an SPF stretch-formed component by utilizing controlled draw-in of sheet metal to the forming chamber prior to application of gas pressure. In an illustrative practice, a preform, similar to a stationary male punch, is placed on the forming press platen opposite the die cavity. An aluminum blank, for example, is placed over the insert and heated to a suitable SPF temperature for the alloy. The die is then moved toward its closed position against the platen. In its closing motion, the die engages the edges of the aluminum sheet. The heated metal is pulled over and around the insert, and draw-in of blank material thus occurs. This results in a greater amount of metal in the die cavity prior to SPF blow forming. The quantity of additional metal can be managed by design of the size, shape and location of the preform on the platen or complementary die member. But the additional metal in the die cavity reduces the amount of strain required and, hence, the amount of thinning to form a desired geometry compared to conventional SPF.

Thus, by the judicious use of a suitable space-occupying metal preform on a die or platen member opposite the forming die, additional metal is easily drawn into the cavity during die closure without significantly increasing the complexity of the tooling. Care is taken in the design of the preform to avoid excessive wrinkling of the drawn-in metal and to maintain a tight gas seal at the periphery of the sheet upon full die closure. The uniformity in thickness of the stretch-formed part is improved. Mass of the formed part can be reduced because the designer does not need to resort to thicker blanks to assure part quality. And, except for the simple preform, there is no increase in the complexity of the SPF tooling.

Quick plastic forming is described in U.S. Pat. No. 6,253,588, issued Jul. 3, 2001 to Rashid, et al, which is hereby incorporated by reference in its entirety. For quick plastic forming, a preferred alloy is Aluminum Alloy 5083 having a typical composition, by weight, of about 4% to 5% magnesium, 0.3 to 1% manganese, a maximum of 0.25% chromium, about 0.1% copper, up to about 0.3% iron, up to about 0.2% silicon, and the balance substantially all aluminum. Generally, the alloy is first hot and then cold rolled to a thickness from about one to about four millimeters.

In the AA5083 alloys, the microstructure is characterized by a principal phase of a solid solution of magnesium in aluminum with well-distributed, finely dispersed particles of intermetallic compounds containing the minor alloying constituents, such as Al6Mn.

Using QPF, large AA5083-type aluminum-magnesium alloy sheet stock may be formed into a complex three-dimensional shape with high elongation regions, like an SPF-formed part, at much higher production rates than those achieved by SPF practices. The magnesium-containing, aluminum sheet is heated to a forming temperature in the range of about 400° C. to 510° C. (750° F. to 950° F.). The forming may often be conducted at a temperature of 460° C. or lower. The heated sheet is stretched against a forming tool and into conformance with the forming surface of the tool by air or gas pressure against the back surface of the sheet. The fluid pressure is preferably increased continuously or stepwise from 0 psi gage at initial pressurization to a final pressure of about 250 to 500 psi (gage pressure, i.e., above ambient pressure) or higher. During the first several seconds up to about, e.g., one minute of increasing pressure application, the sheet accommodates itself on the tool surface. After this initial period of pressurization to initiate stretching of the sheet, the pressure can then be increased at an even faster rate. Depending upon the size and complexity of the floorpan to be formed, such forming can normally be completed in a period of about two to twelve minutes, considerably faster than realized in superplastic forming. Thus, by working a suitably fine grained, aluminum alloy sheet at significantly lower temperatures and continuously increased, higher gas pressures than typical SPF practices, significantly faster and more practical forming (at least for the automobile industry) times are achieved.

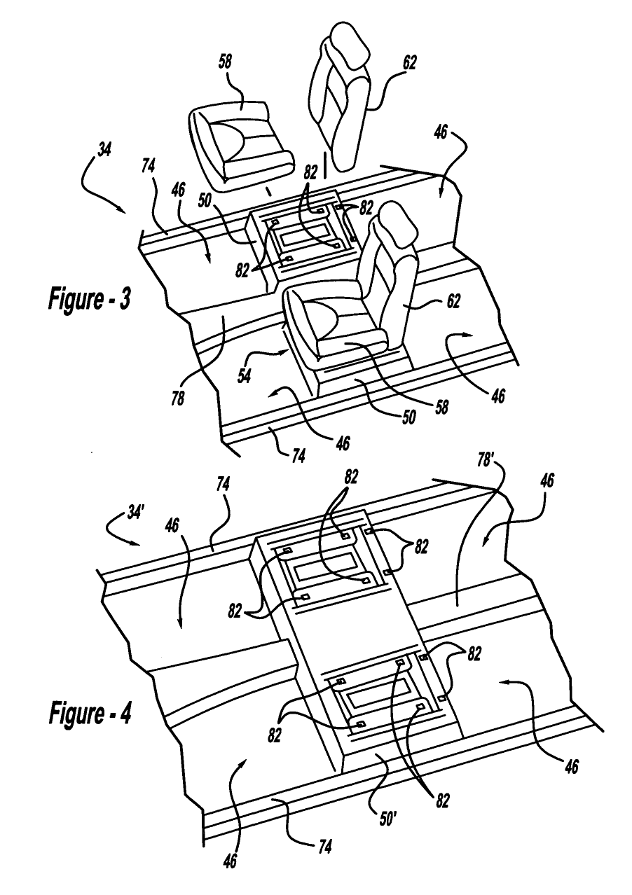

Referring to FIG. 3, wherein like reference numbers refer to like components from FIGS. 1 and 2, a lower seat portion 58 and a seatback portion 62 are connectable to the formations 50 via fastening elements 82. Optionally, and within the scope of the claimed invention, the formations 50 may function as lower seat portions. For example, an occupant may sit directly on a formation 50, or a layer of foam and a fabric covering may be employed on top of the formation 50 to form a lower seat portion. In such an embodiment, a formation 50 may be anatomically contoured for comfort.

The floorpan 34 facilitates the installation of custom tailored seats because the fastening elements 82 form a simplified connection interface to which a variety of differently-configured lower seat portions and seatback portions are mountable. The connection interface on the floorpan may also include an electrical connector (not shown) to provide power to a front seat 54. For example, a seatback portion may include a motor and an adjustment mechanism to tilt the seatback portion, to adjust lumbar support, etc.

A common floorpan configuration may be used with multiple body styles.

Referring to FIG. 4, an alternative embodiment of the floorpan 34' is schematically depicted. The floorpan 34' includes a single formation 50' that extends transversely substantially from one side of the floorpan 34' to the other. The formation 50' forms a portion of two vehicle seats.

While the best modes for carrying out the invention have been described in detail, those familiar with the art to which this invention relates will recognize various alternative designs and embodiments for practicing the invention within the scope of the appended claims.

1. A vehicle body comprising:
a floorpan at least partially defining a passenger compartment;
a front seat in the passenger compartment, the front seat including a lower seat portion and a seatback portion, the lower seat portion being nonadjustable fore or aft by an occupant of the seat; and
at least one drive-by-wire control input device located within the passenger compartment and configured to convert at least one of steering, braking, and propulsion system control signals from mechanical to nonmechanical form.

2. The vehicle body of claim 1, wherein the vehicle body is characterized by the absence of an engine compartment forward of the passenger compartment.

3. The vehicle body of claim 1, wherein the floorpan defines a vehicle floor, and wherein the floorpan is characterized by a formation that supports the lower seat portion above the floor.

4. The vehicle body of claim 1, wherein the floorpan is characterized by a formation that at least partially forms the lower seat portion.

5. The vehicle body of claim 3, wherein the floorpan is one piece.

6. The vehicle body of claim 5, wherein the floorpan is formed using a process selected from the group consisting of quick plastic forming, sheet hydroforming, and superplastic forming.

7. A vehicle comprising:
a vehicle body including a floorpan at least partially defining a passenger compartment;
a front seat in the passenger compartment, the front seat including a lower seat portion and a seatback portion, the lower seat portion being sufficiently nonmovable with respect to the floorpan such that the lower seat portion is nonadjustable fore or aft by an occupant of the seat; and
at least one drive-by-wire control input device located within the passenger compartment and configured to convert at least one of steering, braking, and propulsion system control signals from mechanical to nonmechanical form.

8. The vehicle of claim 7, wherein the vehicle body is characterized by the absence of an engine compartment forward of the passenger compartment.

9. The vehicle of claim 7, wherein the floorpan is characterized by a protuberance that forms a portion of the vehicle seat.

10. The vehicle of claim 9, wherein the floorpan is one-piece.

11. The vehicle body of claim 10, wherein the floorpan is formed using a fluid forming process.

12. A vehicle comprising:
a vehicle body including a floorpan at least partially defining a passenger compartment;
a front seat including a lower seat portion and a seatback portion, the lower seat portion being rigidly mounted with respect to the floorpan such that the lower seat portion is not adjustable fore or aft by an occupant of the seat; and
at least one drive-by-wire control input device located within the passenger compartment and configured to convert mechanical steering control signals to electronic steering control signals, mechanical braking control signals to electronic braking control signals, and mechanical propulsion system control signals to electronic propulsion system control signals;
wherein the floorpan is characterized by a protuberance that forms a portion of the vehicle seat.
